(19) United States
(12) Patent Application Publication
(10) Pub. No.: US 2008/0174660 A1
(43) Pub. Date: Jul. 24, 2008

(54) Light frequency based system and method for creating moving images

(76) Inventor: Arjuna Noor, Malibu, CA (US)

Correspondence Address: EDWIN TARVER, 16830 Ventura Blvd., SUITE 360, Encino, CA, 91436, US

(21) Appl. No.: 11/655,693

(22) Filed: Jan. 19, 2007

(51) Int. Cl. H04N 1/195

(52) U.S. Cl. 348/97; 348/E03.004

(57) ABSTRACT

A system and method for creating static images that give viewers the impression of movement when viewed under regulated changing light conditions. The system and method comprises of a two-dimensional artwork image generated using computerized or traditional means, which imparts a smooth calculus gradient of changing color, texture and pattern; wherein the artwork gives the impression of containing shifting, disappearing and reappearing elements when viewed under a specific type of light environment including an LED based light source with color shifting or color wash capability. The light frequency from the light source is controlled by a computer for producing particular frequency changes and color cycles and may also be controlled manually.

### CROSS-REFERENCE TO RELATED APPPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to creating artwork effects, and more particularly to a light frequency based system for creating moving images by illuminating specially designed artwork with varying frequency and color of lights.

Methods and systems for illuminating the artwork for creating certain visual effects are known in the art. U.S. Pat No. 5,664,352 to Beckman discloses a display arrangement for illuminating posters and other non-opaque planar artwork comprising an item of artwork affixed to an essentially transparent mounting member, and a plurality of precisely configured neon light tubes mounted behind the item of artwork. The light tubes are arranged in a predetermined pattern consonant with the subject matter of the artwork, with each of the light tubes being positioned behind a selected portion of the artwork, to illuminate and enhance such selected portion of the artwork when the light tubes are energized. The light tubes are supported carefully on the rear side of the artwork, with each tube maintained in an appropriate positional relationship with a respective segment of the artwork to be illuminated. An electric power is provided to the light tubes at the appropriate voltage, to bring about the energization of the tubes as well as the illumination of the selected segments of the artwork. However, the technique of illuminating the artwork and the source of illumination are different from the present invention.

U.S. Pub. No. 20040139881 to Kaz discloses a photo storage and emission material with technology for altering color and methods of formulating luminescent inks for color separation of the artwork and printing full color pictorial images with realistic depth. The resulting full color pictorial images are visible in both conditions of reflected light in daylight as well as similar full color emission light in darkness. When the pictorial images are exposed to a bright light source to achieve complete excitation of the photo storage and emission material, the pictorial images exhibit high initial brightness and long glow duration time in darkness. The photo storage and emission inks are utilized in process color separations for printing pictorial images with standard equipment in the printing industry. In this method mixtures of ink composed of photo storage and emission colorants are applied in separate layers, the first made with photo storage and emission colorants and the second made with emission colorants. A luminescent or photo storage and emission undercoating is applied to the substrate, then a translucent pictorial image is transferred and bonded on top of the said undercoating to illuminate the printed image in darkness. However, Kaz concentrates on illumination of images made specifically by photo sensitive ink. In addition, in both the above discussed prior art, the moving effect of the images as an effect of illumination is not achieved.

U.S. Pat. No. 5,138,783 to Forsse discloses a laminate artwork system includes a plurality of stacked, uniformly spaced light transmitting artwork panels, each having a portion of an overall artwork image etched thereon. The artwork panels are generally rectangular and have aligned edges positioned within a frame. The frame houses fluorescent lamps generally adjacent to and extending the length of the panel edges, and includes an inner reflective surface which directs substantially all of the emitted light towards the panel edges. Disposed between the lamp and the panel edges are a plurality of color filters and shutters which control the transmission and intensity of light permitted to pass there through to the edges. A unique visual appearance is attained by illuminating the edge of the artwork panels such that the panels themselves act as conduits for the light to the artwork images. Depending on modulation of the liquid crystal gates, various colors and moving images may be obtained in the stacked panels. However, the artwork and the illumination system of the present invention are different.

It is therefore an object of the present invention to provide a unique combination of technology and art to create a powerful mood enhancing experience for the viewer through image shifting and changing.

A further object is to provide an elegant environment using image shifting artwork in clubs, hotels, spas, hospitals, billboards, commercial places and homes. These and other objects of the present invention will become better understood with reference to the appended Summary, Description, and Claims.

### SUMMARY

The present invention is a light frequency based system for creating static images that gives a viewer the impression of movement. More specifically, the invention comprises a method of generating two-dimensional imagery using a particular set of tools giving an impression of movement including shifting, changing, disappearing and reappearing characteristics when viewed in a specific type of light environment.

The set of tools used in a preferred embodiment of the present invention includes a light source comprising an LED array, a power source and controller operated in connection with the light source. The controller can be a computer control or a color dial. The light is applied to a two-dimensional image comprising a series of sub-images containing a variety of patterns, textures and color arrangements. The two-dimensional images are generated by using different media and different techniques.

### BRIEF DESCRIPTION OF THE FIGURES

FIG. 1 is a diagram of a preferred embodiment of the system of the present invention.

FIG. 2 is a block diagram of a preferred embodiment of the present invention.

### FIGURES—REFERENCE NUMERALS

10 . . . Power Supply
12 . . . Color Dial
14 . . . LED
16 . . . Artwork used with the Present Invention

### DETAILED DESCRIPTION

The present invention comprises a system and method for generating a static two-dimensional images with certain characteristics, causing them to change, appear to move or disappear and reappear with the application of a modulated light frequency.

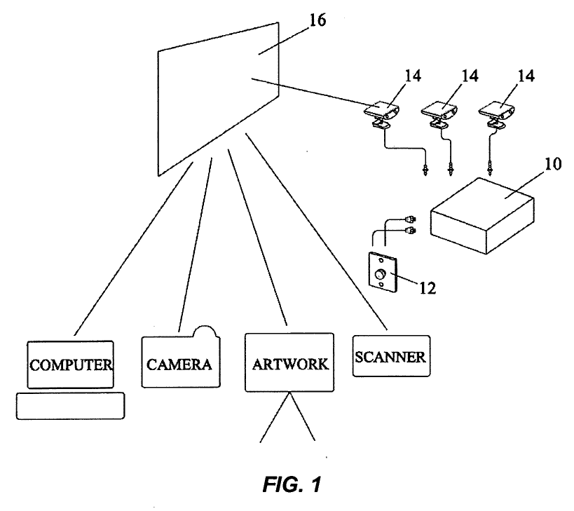

Referring to FIG. 1, according to a preferred embodiment, the light source comprises an LED light array capable of producing light beams of a plurality of colors. The LED light array is powered by a power supply 10, and controlled by a control means comprising a color dial 12 or a computer controller. The LED light array comprises a series of individual LED lights 14 capable of producing different colors, such that the frequency of light changes on a small incremental level over time and a series of color frequencies repeats in a pattern or at random. The color of the light produced by the LED light array in one preferred embodiment of the present invention gradually shifts from one end of the color spectrum to the other, or proceeds through any gradient across the spectrum by gradually increasing or decreasing power to individual LEDs.

The artwork 16 of a preferred embodiment of the present invention comprises an image applied to a two-dimensional medium, such as a canvas or other surface. In another preferred embodiment, the two-dimensional medium is applied across a three dimensional surface, for example, a sculpture or a sofa. The artwork 16 further comprises one or more individual images, colors, patterns and textures within the artwork, designed to absorb the light emitted by the light array at different frequencies.

Still referring to FIG. 1, the individual images, colors, patterns, and textures of the artwork are created combining multiple images using a computerized means. The other methods for creating the artwork comprises exposing the individual frames of films multiple times in-camera, digital photography, scanning images from different sources and creating a single image with multiple layers, and producing multiple layers of images by hand.

Computerized method to create artwork uses a layering means such that each layer has different characteristics in relation to the other layers. For instance, one characteristic contemplated by the method of the present invention is the opacity of a sub-image. The quantitative value of opacity and the qualities of opacity of each layer can be individually controlled such that light from the light source interacts with each layer differently.

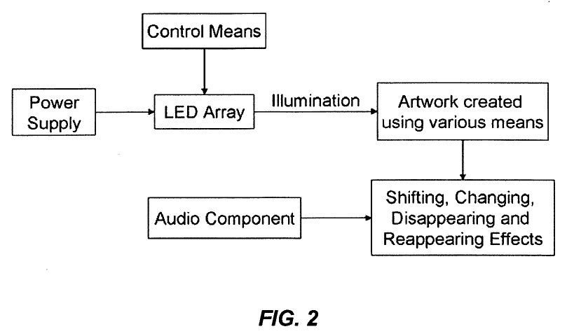

Referring to FIGS. 1 and 2, the characteristics of the artwork 16 used in a preferred embodiment of the invention comprises at least two colors, textures or patterns in order for the image to produce the shifting, changing, disappearing and reappearing effects for a viewer. The artwork with at least two colors, textures, patterns, or a combination of these, gives an illusion of movement as the frequency of the light striking the artwork changes. The individual colors, textures and patterns absorb and reflect different frequencies of light in a way that they appear to shift and change within the artwork. An audio component can be used in synchronization with the light from the LED array.

In addition to the color, texture or pattern characteristics of an image, other variations can be created by using different media including ink, oil, graphite or other means affecting the reflective characteristics of an image to create the artwork. In addition, other characteristics can be attained by changing the two-dimensional medium of the artwork. The other preferred embodiments of the present invention comprises two-dimensional substrates such as large scale computer printed media, computer printed canvas, paper, silk-screen, glass, vinyl, tile, paper or fabric. Images created in multiple exposure photographs, digital photography and laminated images are also contemplated as preferred methods of the present invention.

The artwork may also comprise continuous tone images such that the colors, patterns and textures changes across the surface of the artwork with uniform regularity, or according to a smooth calculus of change. In addition, software based filters applied to individual sub-artwork may alter the appearance of individual layers without affecting the other images, patterns or textures in the artwork as a whole. The overall characteristics of the artwork comprises visual elements that emulate changing spatial relationships from the perspective of a viewer within the artwork, which triggers the illusion of changing, disappearing, reappearing, and shifting movements.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A system for creating moving images, comprising:
(a) an artwork;
(b) an illuminating means capable of producing a variety of colors of light for illuminating the artwork; and
(c) a control means for controlling and modulating the color of the light produced by the illuminating means, wherein portions, or all, of the artwork react differently by either absorbing or reflecting the light incident on them based on the color of the incident light, producing shifting, changing, disappearing and reappearing effects for a viewer as the color of the incident light changes.

2. The system of claim 1, wherein the illuminating means comprises a light emitting diode (LED) array and a power source.

3. The system of claim 2, wherein the LED array comprises a series of individual LEDs capable of producing different colors.

4. The system of claim 1, the control means comprises a setting to make the color of the light produced by the LED light array gradually shift from one end of the color spectrum to the other or shifting randomly across a color spectrum.

5. The system of claim 1, the control means comprises a setting to make the color of the light produced by the LED light array proceed through any
gradient across the spectrum by gradually increasing or decreasing power to individual LEDs.

6. The system of claim 1, wherein the control means comprises a computer controller.

7. The system of claim 1, wherein the control means comprises a color dial.

8. The system of claim 1, wherein the control means comprises a mechanical or computer controlled device that causes the lights to change according to the instructions from the device.

9. The system of claim 1, wherein the control means comprises a setting to change the frequency of the light on a small incremental level over time.

10. The system of claim 1, wherein the control means comprises a setting to produce color cycles, wherein a series of colors are repeated in a pattern, a sequence or at random.

11. The system of claim 1, wherein the portions of the artwork have light reflection or absorption characteristics to emulate changing spatial relationships from the perspective of a viewer within the artwork, which triggers the illusion of changing, disappearing, reappearing, and shifting effects.

12. The system of claim 1, wherein the portions of the artwork comprise different
color, texture, pattern and other light reflection/absorption characteristic elements that emulate changing spatial relationships from the perspective of a viewer within the artwork, which triggers the illusion of disappearing, reappearing, and shifting effects.

13. The system of claim 1, wherein the artwork comprises in-camera multiple exposures to individual frames of film, artwork produced by digital photography, artwork produced by hand with multiple layers of images, colors, patterns or textures, artwork created by scanning works from various sources to create a single work of art containing multiple layers, artwork created by conventional means such as paint, acrylic, pastels and oil, or images created in multiple exposure photographs and laminated images.

14. The system of claim 1, wherein the artwork comprising multiple layers, with each layer having a variety of characteristics in relation with other layers is used such that the incident light interacts with each layer differently.

15. The light frequency based system of claim 14, wherein software based filters applied to individual portions of the artwork alter the appearance of individual layers without affecting the other portions in the artwork.

16. The light frequency based system of claim 1, wherein an audio component is used in synchronization with the light from the illuminating means.
